(19) United States
(12) Patent Application Publication
(10) Pub. No.: US 2025/0052631 A1
(43) Pub. Date: Feb. 13, 2025

(54) ROTOR ASSEMBLY FOR TORQUE SENSOR

(71) Applicant: HL KLEMOVE CORP., Incheon (KR)

(72) Inventors: Jungwook SEO, Incheon (KR); Jinseok BAE, Incheon (KR)

(21) Appl. No.: 18/516,948

(22) Filed: Nov. 22, 2023

(30) Foreign Application Priority Data
Aug. 7, 2023 (KR) 10-2023-0103153

(51) Int. Cl. G01L 5/22; G01L 3/02

(52) U.S. Cl. CPC G01L 5/221; G01L 3/02

(57) ABSTRACT

A rotor assembly of a torque sensor includes: a rotor having a through hole formed along an axial direction so that a steering shaft can be inserted in the through hole; a gear having substantially a ring shape and coupled to the rotor; and a fixing portion configured to fix the rotor to the gear. The fixing portion includes at least one first coupling portion configured to fix the rotor to the gear with respect to the axial direction, and at least one second coupling portion configured to fix the rotor to the gear with respect to a rotation direction. Each of the first coupling portion includes an elastically deformable hook bent from the rotor, and a hook groove penetrating the gear or being depressed from a surface of the gear in a radial direction, such that the hook is inserted in and caught by the hook groove.

### CROSS-REFERENCE TO RELATED APPLICATION(S)

This application is based on and claims priority under 35 U.S.C. § 119 to Korean Patent Application No. 10-2023-0103153, filed on Aug. 7, 2023, in the Korean Intellectual Property Office, the disclosure of which is incorporated by reference herein in its entirety.

### BACKGROUND

### 1. Field

The disclosure generally relates to a rotor assembly of a torque sensor, and more particularly, to a rotor assembly of a torque sensor capable of improving the durability and wear resistance of the rotor assembly with the reduced number of components of the rotor assembly.

### 2. Description of the Related Art

In general, a steering system of a vehicle is a system for changing the direction of wheels through a steering wheel to change a traveling direction of the vehicle in motion. A Motor Driven Power Steering (MDPS) system, which assists a driver's steering force for safety and convenience of driving, is widely used in the steering system, and the MDPS system includes a torque measuring device.

The Torque Measuring Device is Generally Equipped with a Torque Sensor

Existing torque sensors have used welding between components or applied separate components such as retainers to fix a rotor to a gear. However, the welding used to fix the rotor to the gear has caused the complexity of the manufacturing process and an increase of the manufacturing cost, and the application of separate components has caused an increase in the number of components and a decrease of productivity due to an additional manufacturing process. Furthermore, in the case in which separate components are used or applied to fix the rotor to the gear, severe wear may occur between the rotor and a housing because the rotor rotates frequently during the driving of the vehicle, thereby deteriorating the durability and wear resistance of the product.

### SUMMARY

According to an embodiment of the present disclosure, a rotor assembly of a torque sensor may be capable of firmly fixing a rotor to a gear through or with a simple structure.

According to an embodiment of the present disclosure, a rotor assembly of a torque sensor may be capable of improving the durability and wear resistance of the rotor assembly.

According to an embodiment of the present disclosure, a rotor assembly of a torque sensor may be capable of reducing a number of components of the rotor assembly.

According to an embodiment of the present disclosure, a rotor assembly of a torque sensor may be capable of simplifying a process of manufacturing the rotor assembly.

According to an embodiment of the present disclosure, a rotor assembly of a torque sensor may be capable of increasing product productivity and reducing manufacturing cost.

Additional aspects of the disclosure will be set forth in part in the description which follows and, in part, will be obvious from the description, or may be learned by practice of the disclosure.

In accordance with an aspect of the disclosure, a rotor assembly may include: a rotor including a through hole penetrating the rotor along an axial direction, wherein a steering shaft passes through the through hole, a gear being in a shape of a ring and coupled to the rotor; and a fixing portion configured to fix the rotor to the gear; wherein the fixing portion may include at least one first coupling portion configured to fix the rotor to the gear with respect to the axial direction, and at least one second coupling portion configured to fix the rotor to the gear with respect to a rotation direction, and each of the first coupling portion may include a hook bent from the rotor and being elastically deformable, and a hook groove penetrating the gear or being depressed from the gear in a radial direction, wherein the hook may be inserted into and caught by the hook groove.

The hook may include: a first base portion extending upward from the rotor and facing an inner circumferential surface of the gear, a bending portion bent from an end of the first base portion, and a locking portion extending downward from the bending portion and caught by the hook groove.

A lower end of the locking portion may be in close contact with an upward surface of the hook groove.

Each of the second coupling portion may include a supporting rib protruding inward from the inner circumferential surface of the gear, and a pair of press-fit ribs provided in the rotor and being in close contact with both sides of the supporting rib.

Each of the press-fit ribs may include a second base portion extending upward from the rotor, and a plurality of coupling protrusions protruding in a circumferential direction from a side surface of the second base portion and pressed to a side surface of the supporting rib.

An upper surface of each of the coupling protrusions may include a press-fit guide surface inclined.

Each of the first coupling portion may further include a supporting protrusion protruding from the gear and being in close contact with at least one area of the bending portion.

The gear may further include a rotation supporting portion protruding outward from an outer circumferential surface of the gear, wherein at least one portion of the rotation supporting portion may be contactable with the housing, and the rotation supporting portion may extend continuously along a circumferential direction on the outer circumferential surface of the gear.

A plurality of first coupling portions and a plurality of second coupling portions may be provided in such a way as to be alternately arranged along the circumferential direction between the rotor and the gear.

The rotor assembly may further include a sleeve provided inside the gear, having a hollow shape, and configured to rotate together with the steering shaft.

The sleeve may be made of a metal material, the gear may be made of a plastic material, and the gear may be provided in the sleeve by insert molding.

Each of the first coupling portion may further include a hook guide surface provided at a lower end of an inner circumferential surface of the gear, wherein an inner diameter of the hook guide surface may increase gradually downward.

In accordance with an aspect of the disclosure, a rotor assembly may include: a rotor including a through hole penetrating the rotor along an axial direction, wherein a steering shaft passes through the through hole, a gear being in a shape of a ring and coupled to the rotor; and a fixing portion configured to fix the rotor to the gear; wherein the fixing portion may include at least one first coupling portion configured to fix the rotor to the gear with respect to the axial direction, and at least one second coupling portion configured to fix the rotor to the gear with respect to a rotation direction, and each of the first coupling portion may include a hook protruding outward from an outer circumferential of the gear, and a hook rib penetrating the rotor or being depressed from the rotor in a radial direction, wherein the hook is inserted into and caught by the hook rib, the hook rib being elastically deformable.

The hook rib may include: a first base portion extending upward from the rotor and facing an outer circumferential surface of the gear, and a hook groove penetrating the first base portion or being depressed from the first base portion in the radial direction, wherein the hook is inserted into the hook groove.

An upper end of the hook may be in close contact with a downward surface of the hook groove.

Each of the second coupling portion may include a supporting rib protruding inward from an inner circumferential surface of the gear; and a pair of press-fit ribs provided in the rotor and respectively being in close contact with both sides of the supporting rib.

Each of the press-fit ribs may include a second base portion extending upward from the rotor, and a plurality of coupling protrusions protruding in a circumferential direction from a side surface of the second base portion and pressed to a side surface of the supporting rib.

An upper surface of each of the coupling protrusions may include a press-fit guide surface inclined.

The gear may further include a rotation supporting portion protruding outward from an outer circumferential surface of the gear, wherein at least one portion of the rotation supporting portion may be contactable with the housing, and the rotation supporting portion may extend continuously along a circumferential direction on the outer circumferential surface of the gear.

A plurality of first coupling portions and a plurality of second coupling portions may be provided in such a way as to be alternately arranged along a circumferential direction between the rotor and the gear.

The rotor assembly may further include a sleeve provided inside the gear, having a hollow shape, and configured to rotate together with the steering shaft.

The sleeve may be made of a metal material, the gear may be made of a plastic material, and the gear the gear may be provided in the sleeve by insert molding. A lower surface of the hook may include a hook guide surface inclined.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is an exploded perspective view of a torque sensor including a rotor assembly according to an embodiment of the present disclosure;

FIG. 2 is a perspective view of a rotor assembly according to an embodiment of the present disclosure;

FIG. 3 is a top view of a rotor assembly according to an embodiment of the present disclosure;

FIG. 4 is an exploded perspective view of a rotor assembly according to an embodiment of the present disclosure;

FIG. 5 is another perspective view for illustrating a gear according to an embodiment of the present disclosure;

FIG. 6 is another perspective view for showing a rotor and a gear coupled to each other according to an embodiment of the present disclosure;

FIG. 7 is a cross-sectional view taken along a line A-A′ of FIG. 3;

FIG. 8 is a perspective view of a rotor assembly according to another embodiment of the present disclosure;

FIG. 9 is a top view of a rotor assembly according to another embodiment of the present disclosure;

FIG. 10 is an exploded perspective view of a rotor assembly according to another embodiment of the present disclosure;

FIG. 11 is another perspective view for showing a gear according to another embodiment of the present disclosure;

FIG. 12 is another perspective view for showing a rotor and a gear coupled to each other according to another embodiment of the present disclosure; and

FIG. 13 is a cross-sectional view taken along a line B-B′ of FIG. 9.

### DETAILED DESCRIPTION

Hereinafter, embodiments of the disclosure will be described in detail with reference to the accompanying drawings. The following embodiments are provided to transfer the concepts of the present disclosure to one of ordinary skill in the technical art to which the disclosure belongs. However, the present disclosure is not limited to these embodiments, and may be embodied in another form. In the drawings, parts that are irrelevant to the descriptions may be not shown in order to clarify the present disclosure, and also, for easy understanding, the sizes of components are more or less exaggeratedly shown.

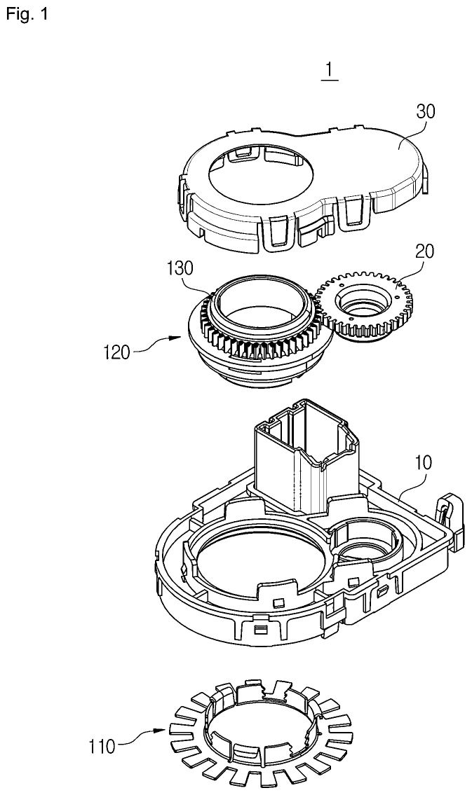

FIG. 1 is an exploded perspective view of a torque sensor 1 including a rotor assembly 100 according to an embodiment of the present disclosure.

Referring to FIG. 1, the torque sensor 1 may include a housing 10, a rotor assembly 100, a sensor gear 20, a cover 30, and printed circuit board (PCB). The housing 10 has an accommodating space in wich various components, such as a rotor 110 and a gear 120 which will be described below, are accommodated and installed. The rotor assembly 100 is configured to be rotatable together with a steering shaft 40. The sensor gear 20 is engaged with the gear 120 and includes a magnetic material for measuring a steering angle of the steering shaft 40. The cover 30 covers the accommodating space of the housing 10 and forms an outer appearance of a product together with the housing 10. Various electronic components are mounted to the PCB to detect a rotation of the rotor 110.

The housing 10 may include an installation opening penetrating the housing 10 along an axial direction of the steering shaft 40 such that the steering shaft 40 and the rotor assembly 100, which will be described below, can penetrate the housing 20 through the installation opening and be installed in the installation opening. The housing 10 may have the accommodating space in which various components including the rotor assembly 100 and the PCB are accommodated and installed. The accommodating space of the housing 10 may be covered by the cover 30, and the housing 10 may be coupled to the cover 30 to form a case and outer appearance of the torque sensor 1.

At least a part of the rotor assembly 100 may be fixed to the steering shaft 40 and rotate together with the steering shaft 40. While a driver manipulates or controls a steering wheel (e.g. a driver rotates the steering wheel), the steering shaft 40 and the rotor assembly 100 may rotate accordingly, and the PCB may detect magnetic induction current generated by a rotation of the rotor 110 to measure and detect a torque applied to the steering shaft 40.

Also, the sensor gear 20 including magnetic material may be rotatably engaged with the gear 120 of the rotor assembly 100. The sensor gear 20 may be rotated by the rotation of the steering shaft 40 and the gear 120, and the PCB may detect a change of a magnetic force or field generated by the rotation of the sensor gear 20 to detect and measure a steering angle of the steering wheel.

Meanwhile, if a torque sensor fixes a rotor of a rotor assembly to a gear by welding the rotor to the gear or by interposing a separate component between the rotor and the gear, the welding of components has caused complexity of a manufacturing process and an increase of manufacturing cost, and the application of a separate component such as a retainer has caused an increase in number of components and a decrease of productivity due to an additional installation process. Furthermore, a relative rotation occurs between the housing and the gear repeatedly rotating by steering. However, in the torque sensor, an area allowing the relative rotation is small due to a complicated coupling structure, which deteriorates wear resistance and durability of the product.

For this reason, the rotor assembly 100 of the torque sensor 1 according to an embodiment of the present disclosure may firmly fix the rotor 110 to the gear 120 through a simple structure, while reducing a number of components of the torque sensor 1 and simplifying a manufacturing process of the torque sensor 1. In addition, the rotor assembly 100 may improve wear resistance and the durability of a product by enlarging an area allowing a relative rotation between the gear 120 and the housing 10.

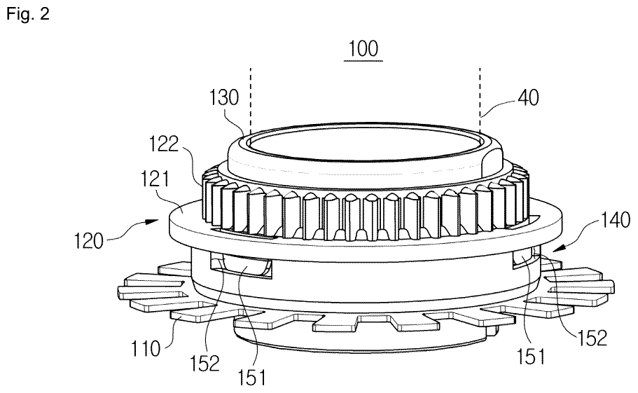

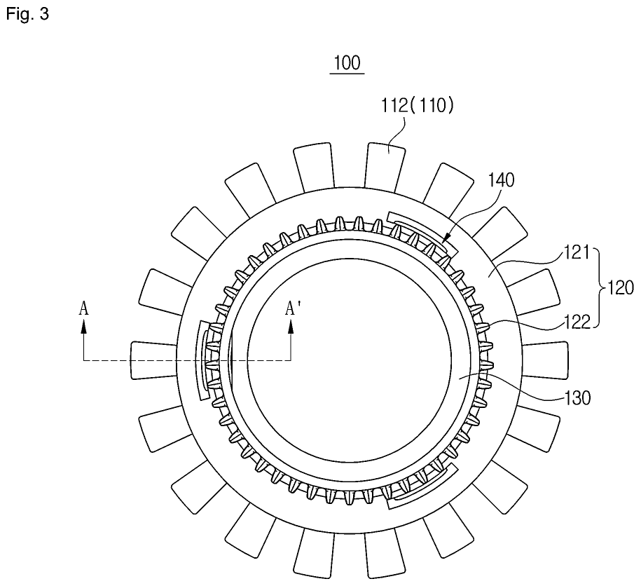

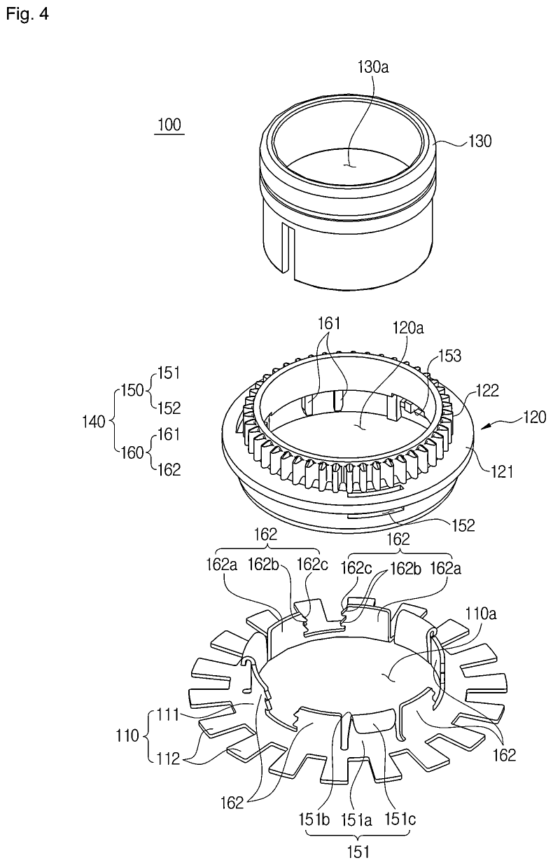

FIG. 2 is a perspective view of the rotor assembly 100 according to an embodiment of the present disclosure, FIG. 3 is a top view of the rotor assembly 100 according to an embodiment of the present disclosure, and FIG. 4 is an exploded perspective view of the rotor assembly 100 according to an embodiment of the present disclosure.

Referring to FIGS. 2 to 4, the rotor assembly 100 of the torque sensor 1 according to an embodiment of the present disclosure may include the rotor 110, the gear 120, a sleeve 130, and a fixing portion 140. The rotor 110 has a through hole 110a through which the steering shaft 40 passes. The gear 120 is coupled to the rotor 110. The sleeve 130 is configured to be rotatable together with the steering shaft 40 and coupled to the gear 120. The fixing portion 140 is configured to fix the rotor 110 to the gear 120.

The rotor 110 may include the through hole 110a which penetrates the rotor 110 along the axial direction of the rotor 110 and through which the steering shaft 40 passes. The rotor 110 may be fixed to the steering shaft 40 by a medium of the gear 120 and the sleeve 130, that will be described below, in order to rotate together with the steering shaft 40. The rotor 110 may include a body 111 in which the through hole 110a is formed and which has a substantially ring shape, and a plurality of blades 112 protruding outward in a radial direction from an outer circumferential surface of the body 111. Slits may be formed between the blades 112 of the rotor 110. The rotor 110 may be made of a metal material to generate magnetic induction current, and the blades 112 of the rotor 110 may be rotatable together with the steering shaft 40 by a rotation of the steering shaft 40. The PCB may detect the magnetic induction current generated by the rotation of the blades 112 of the rotor 110 to detect and measure a torque applied to the steering shaft 40 by the driver. The fixing portion 140 which will be described below may be provided in the body 111 of the rotor 110, and details about the fixing portion 140 will be described below.

The gear 120 may be substantially in a shape of a ring and may be fixed to the rotor 110 by the fixing portion 140 which will be described below. Also, the gear 120 may be rotatable together with the steering shaft 40 by a medium of the sleeve 130 by being coupled to the sleeve 120 which will be described below. A through hole 120a through which the steering shaft 40 passes may be formed in an inner portion of the gear 120, and accordingly, the gear 120 may be substantially in a shape of a ring. The gear 120 may be made of, for example, but not limited to, a plastic material for weight lightening and operating noise reduction of the product. However, the gear 120 can be made of any suitable material. The gear 120 may be rotatably accommodated and supported in the accommodating space of the housing 10. Gear teeth 122 that are engaged with the sensor gear 20 may be formed at an upper portion of the gear 120 or arranged along an upper outer circumferential surface of the gear 120, and the fixing portion 140 which will be described below may be provided below the gear 120 or be coupled to a lower portion of the gear 120.

A rotation supporting portion or rotation support 121 may be provided or formed between the gear teeth 122 and the fixing portion 140 (e.g. at a center between the gear teeth 122 and the fixing portion 140). The rotation supporting portion 121 may rotatably support the gear 120 in the accommodating space of the housing 10, and allow a relative rotation of the gear 120 with respect to the housing 10. For example, the rotation supporting portion 121 may protrude outward in the radial direction of the gear 120 from an outer circumferential surface of the gear 120, and at least a part of the rotation supporting portion 121 may be contactable with the housing 10 in order to accept wear that is caused by a relative rotation of the gear 120 with respect to the housing 10.

In the rotor assembly 100 according to an embodiment of the present disclosure, because the fixing portion 140 fixes the rotor 110 to the gear 120 through or by a simple structure, which will be described below, a degree of freedom with respect to a shape and size of the rotation supporting portion 121 may increase, and accordingly, the rotation supporting portion 121 may extend continuously along a circumferential direction on the outer circumferential surface of the gear 120. In other words, if the torque sensor has limitation in securing an area of contact between the housing and the gear by performing welding or interposing a separate component to fix the rotor to the gear, the area of contact may be reduced, which deteriorates wear resistance of the housing or the gear. However, according to an embodiment of the present disclosure, the rotor assembly 100 fixes the rotor 110 to the gear 120 through or by a simple structure, and therefore the rotation supporting portion 121 may have substantially a ring shape protruding continuously from the outer circumferential surface of the gear 120 and be rotatably supported to the housing 10. Thereby, an area of contact between the housing 10 and the gear 120 may be enlarged, and accordingly, wear resistance between the housing 10 and the gear 120 may be improved despite repeated rotations of the gear 120 with respect to the housing 10.

The sleeve 130 may have a hollow shape and include a through hole 130a which the steering shaft 40 passes through and is pressed to. The sleeve 130 may be fixedly coupled to the steering shaft 40 such that an inner circumferential surface of the sleeve 130 presses an outer circumferential surface of the steering shaft 40. The sleeve 130 may be made of, for example, but not limited to, a metal material. However, the sleeve 130 can be made of any suitable material. At least a part of the sleeve 130 may be disposed or provided inside the gear 120. To simplify a process of assembling the sleeve 130 and the gear 120, the gear 120 may be manufactured and coupled to the sleeve 130 by insert-molding. Because the sleeve 130 is pressed into and fixed to the steering shaft 40, the sleeve 130 is coupled to the gear 120 by the insert-molding, and the gear 120 is coupled to the rotor 110 by the fixing portion 140, which will be described below, the steering shaft 40, the sleeve 130, the gear 120, and the rotor 110 may be axially fixed and rotate together.

The fixing portion 140 may fix the rotor 110 to the gear 120 by or through a simple structure and a simple assembly process.

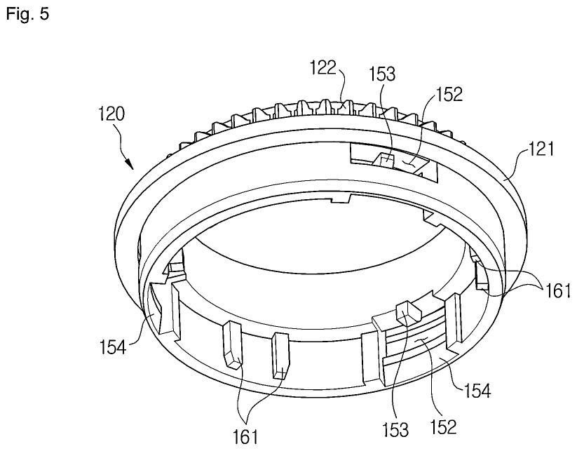

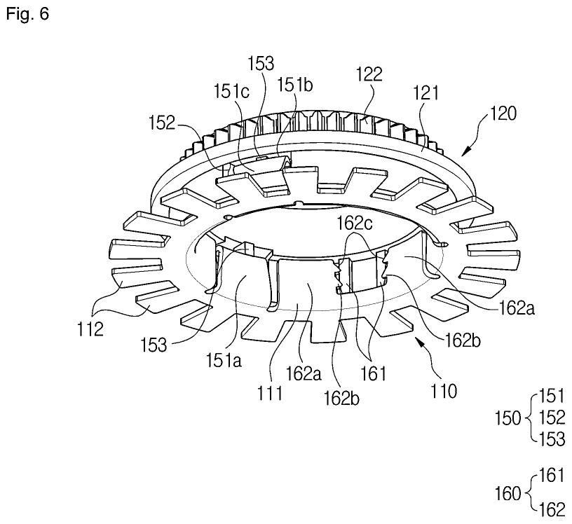

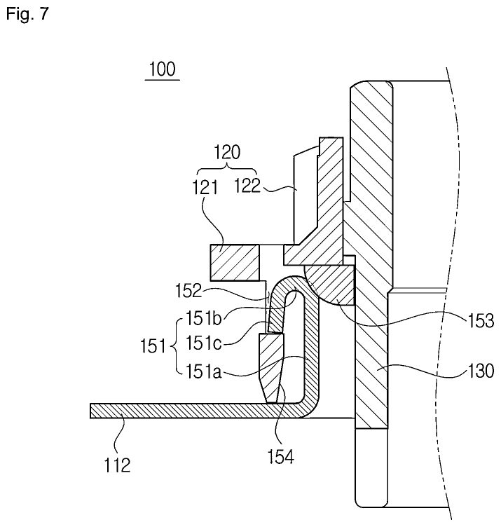

FIG. 5 is another perspective view for illustrating the gear 120 according to an embodiment of the present disclosure, FIG. 6 is another perspective view showing the rotor 110 and the gear 120 coupled to each other according to an embodiment of the present disclosure, and FIG. 7 is a cross-sectional view taken along a line A-A′ of FIG. 3.

Referring to FIGS. 4 to 7, the fixing portion 140 may include at least one first coupling portion 150 for fixing the rotor 110 to the gear 120 with respect to the axial direction, and at least one second coupling portion 160 for fixing the rotor 110 to the gear 120 with respect to a rotation direction or a circumferential direction. A plurality of first coupling portions 150 and a plurality of second coupling portions 160 may be provided in such a way as to be alternately arranged along the circumferential direction between the rotor 110 and the gear 120. The first coupling portions 150 and the second coupling portions 160 may be provided in various numbers as long as the first coupling portions 150 and the second coupling portions 160 are capable of stably fixing the rotor 110 to the gear 120.

One or more first coupling portions 150 may be provided between the rotor 110 and the gear 120 to fix the rotor 110 to the gear 120 with respect to the axial direction. Each of the first coupling portions 150 may include a hook 151, a hook groove 152, and a supporting protrusion 153, The hook 151 may be extended or bent from the rotor 110. The hook groove 152 may be provided at or in the gear 120, and the hook 151 is inserted into and coupled to the hook groove 152. The supporting protrusion 153 may be provided in the gear 120, and the supporting protrusion 153 is in close contact with the hook 151.

The hook 151 may be extended and bent from the body 111 of the rotor 110, and elastically deformable or flexible to stably enter, or be inserted into, the hook groove 152 which will be described below and be coupled to the hook groove 152. The hook 151 may include a first base portion 151a, a bending portion 151b, and a locking portion 151c. The first base portion 151a may be bent and extended upward from the rotor 110 (e.g. extending in a direction perpendicular to a plane of the rotor 110). The bending portion 151b may be extended and bent from an upper end of the first base portion 151a. The locking portion 151c may be extended downward from the bending portion 151b.

The first base portion 151a may be substantially in a shape of a plate extending upward from an inner circumferential surface of the blades 112 on the body 111 of the rotor 110. The first base portion 151a may be positioned inside the gear 120 in a state that the rotor 110 and the gear 120 are assembled together, and accordingly, an outward surface of the first base portion 151a may face an inner circumferential surface of the gear 120. The bending portion 151b may be bent outward and downward from the upper end of the first base portion 151a. As described above, the rotor 110 may be made of a metal material, and the bending portion 151b may be formed by bending the upper end of the first base portion 151a outward and downward.

The locking portion 151c may extend downward from the bending portion 151b, and may be caught by or interlocked with the hook groove 152 of the gear 120 which will be described below. A lower end of the locking portion 151c may be in close contact with an upward surface of the hook groove 152 which will be described below to prevent the rotor 110 from departing or falling out from the gear 120 and firmly fix the rotor 110 to the gear 120 with respect to the axial direction. Because the hook 151 is elastically deformable or flexible, the hook 151 may move toward the hook groove 152, upon assembly of the rotor 110 and the gear 120, in a state of being pressed inward in the radial direction while being in close contact with the inner circumferential surface of the gear 120, and when the locking portion 151c of the hook 151 is inserted into the hook groove 152, the hook 151 may be restored to its original shape by an elastic restoring force to fix the rotor 110 to the gear 120 with respect to the axial direction. In order to enable the bending portion 151b and the locking portion 151c to easily enter or be inserted into the inner circumferential surface of the gear 120 while the hook 151 enters or is inserted into the inner circumferential surface of the gear 120 for the assembly of the rotor 110 and the gear 120, a hook guide surface 154 inclined such that an inner diameter increases gradually downward may be provided at a lower end portion of the inner circumferential surface of the gear 120.

The hook groove 152 may penetrate the gear 120 or be depressed from the inner surface of the gear 120 such that the hook 151 can be inserted into and caught by the hook groove 152. The hook groove 152 may penetrate the gear 120 in the radial direction, and the locking portion 151c of the hook 151 may be inserted into and interlocked or coupled to the gear 120 from inside of the gear 120 toward the outside of the gear 120 to fix the rotor 110 to the gear 120 with respect to the axial direction. Also, the upward surface of the hook groove 152 may be in close contact with the lower end of the locking portion 151c to prevent the rotor 110 from departing or falling out from the gear 120. Meanwhile, FIGS. 3 to 7 show an exemplary embodiment in which the hook groove 152 penetrates the gear 120. Alternatively, the hook groove 152 may be depressed on or in the inner circumferential surface of the gear 120 in the radial direction such that the locking portion 151c of the hook 151 is inserted into and coupled to the hook groove 152.

The supporting protrusion 153 may be in contact with at least one portion of the bending portion 151b to support the hook 151. The supporting protrusion 153 may protrude from the inner circumferential surface of the gear 120 and be in close contact with an upper part of the bending portion 151b to stably maintain and support the hook 151 on the gear 120. The supporting protrusion 153 may be formed integrally with the gear 120 by or upon the injection molding of the gear 120.

One or more second coupling portions 160 may be positioned between the rotor 110 and the gear 120 to fix the rotor 110 to the gear 120 with respect to the rotation direction. Each of the second coupling portions 160 may include a supporting rib 161 protruding from the gear 120, and a pair of press-fit ribs 162 provided in the rotor 110 and respectively being in close contact with both sides of the supporting rib 161 or the pair of the supporting ribs 161.

The supporting rib 161 may protrude inward in the radial direction from the inner circumferential surface of the gear 120. Also, the supporting rib 161 may extend in the axial direction to be stably coupled to the press-fit ribs 162. The pair of press-fit ribs 162 may be provided on the body 111 of the rotor 110 and positioned to or around both sides of the supporting rib 161 to be in close contact with and pressed to, or to support, both side surfaces of the supporting rib 161 to limit the movement of the press-fit rib 162 in a circumferential direction. Each of the press-fit ribs 162 may include a second base portion 162a bent and extending upward from the rotor 110, and a plurality of coupling protrusions 162b protruding in the circumferential direction from a side surface of the second base portion 162a and pressed to, or supporting, a side surface of the supporting rib 161.

The second base portion 162a may be substantially in a shape of a plate extending upward from the inner circumferential surface of the blades 112 on the body 111 of the rotor 110. The second base portion 162a may be positioned inside the gear 120 upon assembly of the rotor 110 and the gear 120, and accordingly, an outward surface of the second base portion 162a may face the inner circumferential surface of the gear 120. Upon coupling of the rotor 110 to the gear 120, a pair of second base portions 162a may be positioned to both sides of each supporting rib 161, and the coupling protrusions 162b protruding from the side surfaces of the second base portions 162 may be in close contact with and pressed to the side surfaces of the supporting rib 161, thereby fixing the rotor 110 to the gear 120 with respect to the rotation direction.

An upward surface of each coupling protrusion 162b may include a press-fit guide surface 162c that is inclined. The press-fit guide surface 162c may be provided at the upward surface of the coupling protrusion 162b and inclined upward toward a side surface of the second base portion 162a. Accordingly, the press-fit guide surface 162c may enable the supporting rib 161 to easily enter or be inserted between the pair of second base portions 162a, and the coupling protrusions 162b to be easily pressed to or support the supporting rib 161. Also, a downward surface of the coupling protrusion 162b may have an angle corresponding to an angle that is perpendicular to the side surface of the second base portion 162a, thereby preventing the gear 120 from departing or falling out from the rotor 110 in the axial direction.

Hereinafter, a rotor assembly 200 of the torque sensor 1 according to another embodiment of the present disclosure will be described.

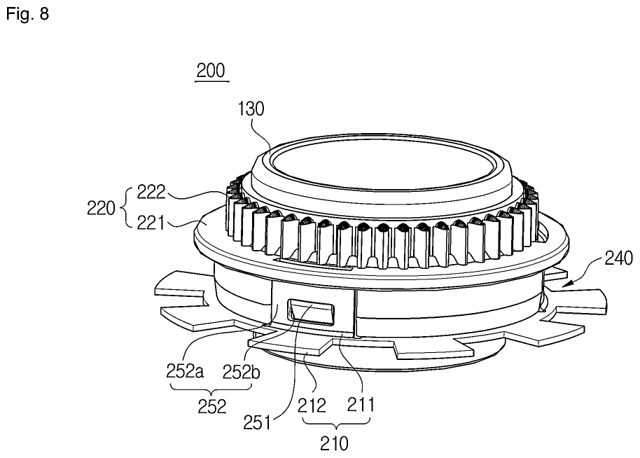

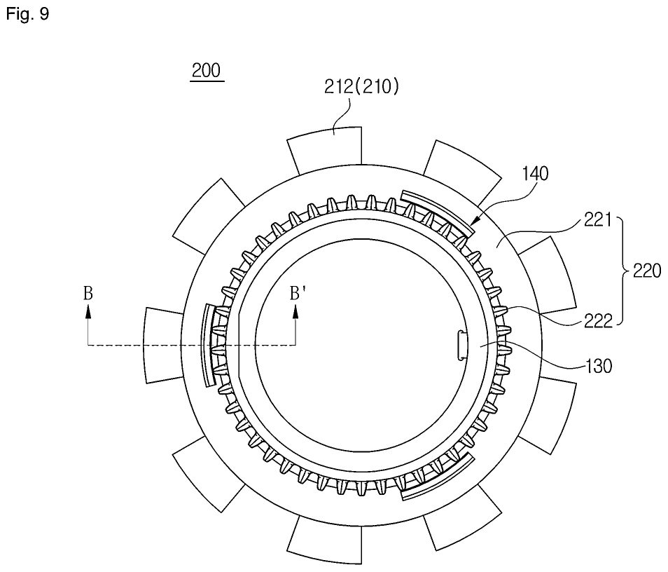

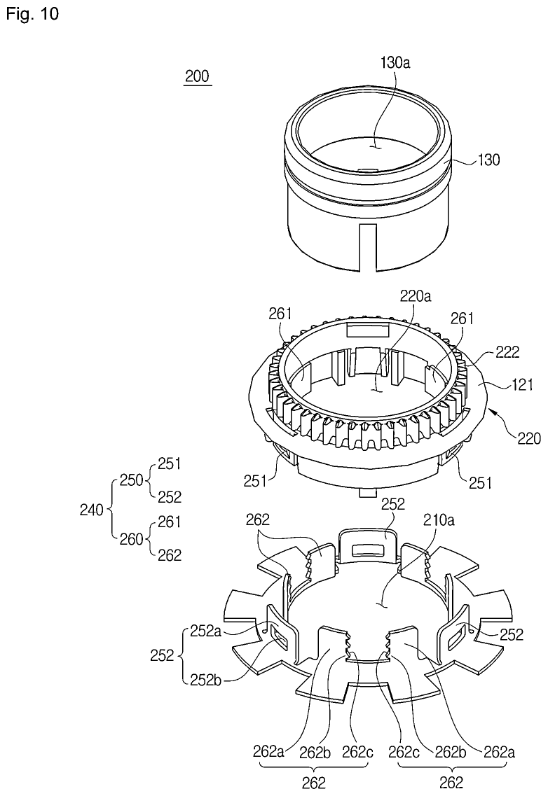

FIG. 8 is a perspective view of the rotor assembly 200 according to another embodiment of the present disclosure. FIG. 9 is a top view of the rotor assembly 200 according to another embodiment of the present disclosure, and FIG. 10 is an exploded perspective view of the rotor assembly 200 according to another embodiment of the present disclosure.

Referring to FIGS. 8 to 10, the rotor assembly 200 of the torque sensor 1 according to an embodiment of the disclosure may include a rotor 210, a gear 220, a sleeve 130, and a fixing portion 240. The rotor 210 may include a through hole 210a through which the steering shaft 40 passes. The gear 220 may be coupled to the rotor 210. The sleeve 130 may rotate together with the steering shaft 40 and be coupled to the gear 220. The fixing portion 240 is configured to fix the rotor 210 to the gear 220.

The rotor 210 may include the through hole 210a. The through hole 210a may penetrate the rotor 210 along an axial direction of the rotor 210 and the steering shaft 40 passes the through hole 210a. The rotor 210 may be fixed to the steering shaft 40 by a medium of the gear 220 and the sleeve 130, which will be described below, in order to rotate together with the steering shaft 40. The rotor 210 may include a body 211 and a plurality of blades 212. The body 211 may have substantially a ring shape, and the through hole 210a is formed in the body 211. The plurality of blades 212 may protrude outward in the radial direction from an outer circumferential surface of the body 211. The rotor 210 may be made of, for example, but not limited to, a metal material to generate magnetic induction current. However, the rotor 210 can be made of any material capable of generating magnetic induction current. The blades 212 of the rotor 210 may be rotatable together with the steering shaft 40 by a rotation of the steering shaft 40. A PCB may detect the magnetic induction current generated by the rotation of the blades 212 to detect and measure a torque applied to the steering shaft 40. The fixing portion 240, which will be described below, may be provided in the body 211 of the rotor 210, and details about the fixing portion 240 will be described below.

The gear 220 may be substantially in a shape of a ring and fixed to the rotor 210 by the fixing portion 240 which will be described below. Also, the gear 220 may be coupled to the sleeve 130 which will be described below to rotate together with the steering shaft 40 by a medium of the sleeve 130. A through hole 220a through which the steering shaft 40 passes may be formed in an inner portion of the gear 220, and accordingly, the gear 220 may be substantially in a shape of a ring. The gear 220 may be made of, for instance, but not limited to, a plastic material for weight lightening and operating noise reduction of a product. However, the gear 220 may be made of any suitable material. The gear 220 may be rotatably accommodated and supported in an accommodating space of a housing 10. Gear teeth 222 that are engaged with the sensor gear 20 may be formed at an upper portion of the gear 220 or arranged along an upper outer circumferential surface of the gear 220, and the fixing portion 240 which will be described below may be provided below the gear 220 or be coupled to a lower portion of the gear 220.

A rotation supporting portion or rotation support 221 may be provided or formed between the gear teeth 222 and the fixing portion 240 (e.g. at a center between the gear teeth 222 and the fixing portion 240 of the gear 220). The rotation supporting portion 221 may rotatably support the gear 220 in the accommodating space of the housing 20, and allow a relative rotation of the gear 220 with respect to the housing 20. For example, the rotation supporting portion 221 may protrude outward in the radial direction of the gear 220 from an outer circumferential surface of the gear 220, and at least one area of the rotation supporting portion 221 may be in contact to the housing 20 in order to accept wear that is caused by a relative rotation of the gear 220 with respect to the housing 10.

In the rotor assembly 200 according to an embodiment of the present disclosure, because the fixing portion 240 fixes the rotor 210 to the gear 220 through or by a simple structure, which will be described below, a degree of freedom with respect to a shape and size of the rotation supporting portion 221 may increase, and accordingly, the rotation supporting portion 221 may extend continuously along a circumferential direction on the outer circumferential surface of the gear 220. In other words, if the torque sensor has limitation in securing an area of contact between the housing and the gear by performing welding or interposing a separate component to fix the rotor to the gear, the area of contact may be reduced, which deteriorates wear resistance of the housing or the gear. However, according to an embodiment of the present disclosure, the rotor assembly 200 fixes the rotor 210 to the gear 220 through or by a simple structure, and therefore the rotation supporting portion 221 may have substantially a ring shape protruding continuously from the outer circumferential surface of the gear 220 and be rotatably supported to the housing 20. Accordingly, an area of contact between the housing 20 and the gear 220 may be enlarged, and wear resistance between the housing 20 and the gear 220 may be improved despite repeated rotations of the gear 220 with respect to the housing 20.

The sleeve 130 may have a hollow shape, and may be fixedly coupled to the steering shaft 40 such that the inner circumferential surface of the sleeve 130 presses the outer circumferential surface of the steering shaft 40. The sleeve 130 may be made of, for example, but not limited to, a metal material. However, the sleeve 130 can be made of any suitable material. At least a part of the sleeve 130 may be disposed or provided inside the gear 220. To simplify a process of assembling the sleeve 130 and the gear 220, the gear 220 may be manufactured and coupled to the sleeve 130 by the insert-molding. Because the sleeve 130 is pressed into and fixed to the steering shaft 40, the sleeve 130 is coupled to the gear 220 by insert molding, and the gear 220 is coupled to the rotor 210 by the fixing portion 240 which will be described below, the steering shaft 40, the sleeve 130, the gear 220 and the rotor 210 may be axially fixed and rotatable together.

The fixing portion 140 may fix the rotor 210 to the gear 220 by or through a simple structure and a simple assembly process.

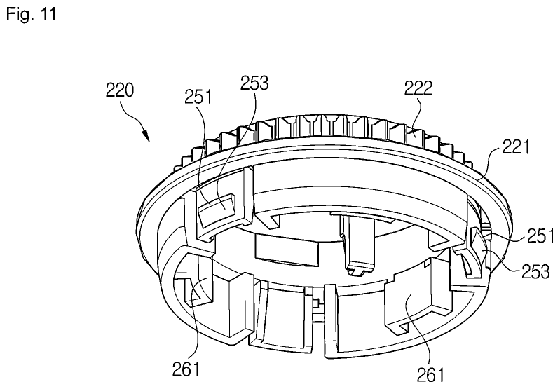

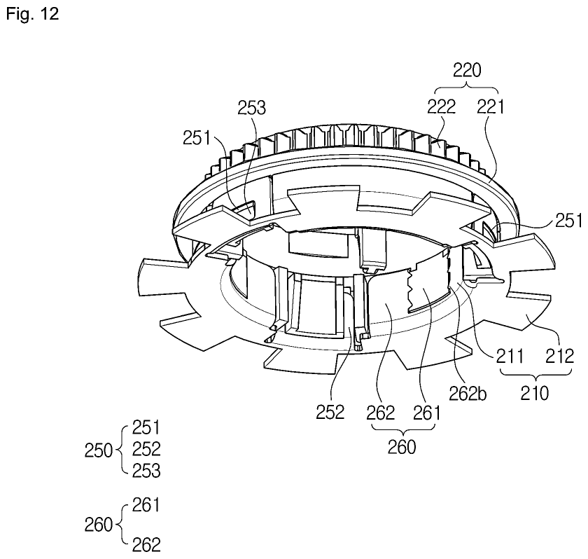

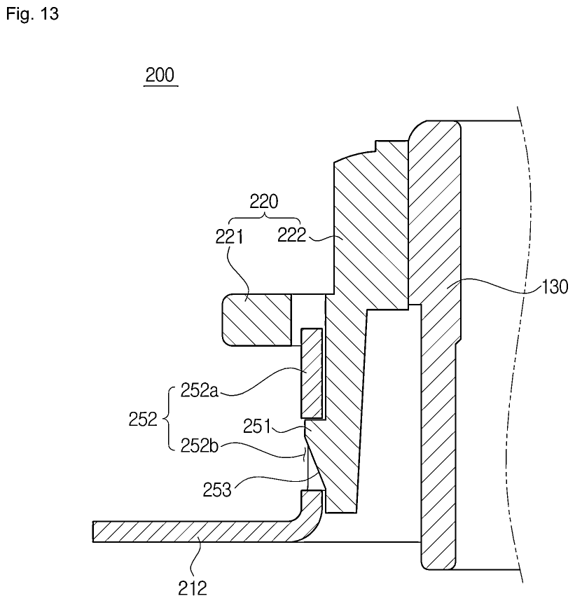

FIG. 11 is another perspective view for illustrating the gear 220 according to an embodiment of the present disclosure, and FIG. 12 is another perspective view for showing the rotor 210 and the gear 220 coupled to each other according to another embodiment of the present disclosure. FIG. 13 is a cross-sectional view taken along a line B-B′ of FIG. 9.

Referring to FIGS. 10 to 13, the fixing portion 240 may include at least one first coupling portion 250 for fixing the rotor 210 to the gear 220 with respect to the axial direction, and at least one second coupling portion 260 for fixing the rotor 210 to the gear 220 with respect to the rotation direction or a circumferential direction. A plurality of first coupling portions 250 and a plurality of second coupling portions 260 may be provided in such a way as to be alternately arranged along the circumferential direction between the rotor 210 and the gear 220. The first coupling portions 250 and the second coupling portions 260 may be provided in various numbers as long as the first coupling portions 250 and the second coupling portions 260 are capable of stably fixing the rotor 210 to the gear 220.

One or more first coupling portions 250 may be provided between the rotor 210 and the gear 220 to fix the rotor 210 to the gear 220 with respect to the axial direction. Each of the first coupling portions 250 may include a hook 251 provided in the gear 220, and a hook rib 252 provided in the rotor 210. The hook 251 is inserted into and coupled to the hook rib 252.

The hook 251 may protrude outward from an outer circumferential surface of the gear 220 and may be caught by the hook groove 252b of the rotor 210 which will be described below. The hook 251 may be injection molded integrally with the gear 220, and when the hook 251 is inserted into and coupled to the hook groove 252b which will be described below, an upper end of the hook 251 may be in close contact with a downward surface of the hook groove 252b to firmly fix the rotor 210 to the gear 220. Also, for the hook 251 to stably maintain a coupled state inside the hook rib 252, the upper end of the hook 251 may protrude with an angle corresponding to an angle that is perpendicular to the outer circumferential surface of the gear 220, thereby preventing the rotor 210 from falling out or departing from the gear 220 in the axial direction. A lower surface of the hook 251 may be provided as a hook guide surface 253 of which a protruded height or thickness from the gear 220 decreased gradually downward and which is inclined or slanted such that when the hook 251 enters an inner circumferential surface of the hook rib 252 which will be described below for assembly of the rotor 210 and the gear 220, the hook 251 easily enters or is easily inserted into the inner circumferential surface of the hook rib 252.

The hook rib 252 may be provided in the rotor 210 and the hook 251 may be inserted into and interlocked with or caught by the hook rib 252. More specifically, the hook rib 252 may include a first base portion 252a, and a hook groove 252b. The first base portion 252a may be bent and extend upward from the rotor 210 and face the outer circumferential surface of the gear 220. The hook groove 252b may penetrate the first base portion 251a or depressed from the first base portion 251a in the radial direction The hook 251 is inserted into and interlocked with or caught by the hook groove 252b. The hook rib 252 may be made of, for example, but not limited to, a metal material, like the rotor 210, and be configured to be elastically deformable or flexible to be assembled with and coupled to the hook 251. However, the hook rib 252 can be made of any suitable material capable of being elastically deformable or flexible.

The first base portion 252a may be substantially in a shape of a plate bent and extending upward from an inner circumferential surface of the blades 212 on the body 211 of the rotor 210. The first base portion 252a may be positioned outside the gear 220 in a state that the rotor 210 and the gear 220 are assembled together, and accordingly, an inner surface of the first base portion 252a may face the outer circumferential surface of the gear 220. The hook groove 252b may penetrate the first base portion 252a or be depressed from the inner surface of the first base portion 252a in the radial direction, and the hook 251 may be inserted into and interlocked with or caught by the hook groove 252b. The hook 251 of the gear 220 may enter and move along the inner circumferential surface of the first base portion 252a and then be inserted into the hook groove 252b from the inside of the rotor 210 toward the outside of the rotor 210, and the upper end of the hook 251 may be caught by the downward surface of the hook groove 252b, thereby fixing the rotor 210 to the gear 220 with respect to the axial direction. More specifically, because the hook rib 252 is elastically deformable or flexible, the hook 251 may move toward the hook groove 252b, upon the assembly of the rotor 210 and the gear 220, in a state in which the hook rib 252 is pressed outward in the radial direction while the hook 251 is in close contact with the inner circumferential surface of the hook rib 252, and when the hook 251 is inserted into the hook groove 252b, the hook rib 252 may be restored to its original shape by an elastic restoring force to fix the rotor 210 to the gear 220 with respect to the axial direction. Meanwhile, FIGS. 10 to 13 show an exemplary embodiment in which the hook groove 252b penetrates the hook rib 252. However, the hook groove 252b may be depressed from the inner circumferential surface of the hook rib 252 in the radial direction, and accordingly, the hook 251 may be inserted into and interlocked with or coupled to the hook groove 252b.

One or more second coupling portions 260 may be positioned between the rotor 210 and the gear 220 to fix the rotor 210 to the gear 220 with respect to the rotation direction. Each of the second coupling portions 260 may include a supporting rib 261 protruding from the gear 220, and a pair of press-fit ribs 262 provided in the rotor 210 and being in close contact with both sides of the supporting rib 261 or the pair of the supporting ribs 261.

The supporting rib 261 may protrude Inward in the radial direction from the inner circumferential surface of the gear 220. Also, the supporting rib 261 may extend along the axial direction to be stably coupled to the press-fit ribs 262. The pair of press-fit ribs 262 may be provided on the body 211 of the rotor 210, and positioned to or around both sides of the supporting rib 261 to be in close contact with and pressed to, or to support, both side surfaces of the supporting rib 261 to limit the movement of the press-fit rib 262 in a circumferential direction. Each of the press-fit ribs 262 may include a second base portion 262a bent and extending upward from the rotor 110, and a plurality of coupling protrusions 262b protruding in the radial direction from a side surface of the second base portion 262a and pressed to, or supporting, a side surface of the supporting rib 261.

The second base portion 262a may be substantially in a shape of a plate extending upward from the inner circumferential surface of the blades 212 on the body 211 of the rotor 210. The second base portion 262a may be positioned inside the gear 220 upon assembly of the rotor 210 and the gear 220, and accordingly, an outward surface of the second base portion 262a may face the inner circumferential surface of the gear 220. Upon coupling of the rotor 210 to the gear 220, a pair of second base portions 262a may be positioned to both sides of each supporting rib 261, and the coupling protrusions 262b protruding from the side surfaces of the second base portions 262a may be in close contact with and pressed to the side surfaces of the supporting rib 261, thereby fixing the rotor 210 to the gear 220 with respect to the rotation direction.

An upward surface of each coupling protrusion 262b may include a press-fit guide surface 262c that is inclined. The press-fit guide surface 262c may be provided at the upward surface of the coupling protrusion 262b and inclined upward toward the side surface of the second base portion 262a. Accordingly, the press-fit guide surface 262c may enable the supporting rib 261 to easily enter or be inserted between the pair of second base portions 262a, and the coupling protrusions 262b to be easily pressed to or support the supporting rib 261. Also, a downward surface of the coupling protrusion 262b may have an angle corresponding to an angle that is perpendicular to the side surface of the second base portion 262a, thereby preventing the gear 220 from departing or falling out from the rotor 210 in the axial direction.

Therefore, the rotor assembly of the torque sensor according to some embodiments of the present disclosure may firmly fix the rotor to the gear with a simple structure.

The rotor assembly of the torque sensor according to certain embodiments of the present disclosure may improve the durability and wear resistance of the product of the torque sensor.

The rotor assembly of the torque sensor according to various embodiments of the present disclosure may reduce a number of components of the rotor assembly.

The rotor assembly of the torque sensor according to certain embodiments of the present disclosure may simplify a process of manufacturing the rotor assembly.

The rotor assembly of the torque sensor according to some embodiments of the present disclosure may increase product productivity and reduce manufacturing cost.

What is claimed is:

1. A rotor assembly comprising:
a rotor having a through hole formed along an axial direction so that a steering shaft is inserted in the through hole of the rotor;
a gear having a substantially ring shape and coupled to the rotor; and
a fixing portion configured to fix the rotor to the gear, the fixing portion comprising:
at least one first coupling portion configured to fix the rotor to the gear with respect to the axial direction, the at least one first coupling portion comprising an elastically deformable or flexible hook bent from the rotor and a hook groove penetrating the gear or depressed from a surface of the gear in a radial direction such that the hook is inserted in the hook groove.

2. The rotor assembly of claim 1, wherein the hook includes:
a first base portion extending upward from the rotor and facing an inner circumferential surface of the gear,
a bent portion bent from an end of the first base portion, and
a locking portion extending downward from the bent portion and coupled to the hook groove.

3. The rotor assembly of claim 2, wherein a lower end portion of the locking portion of the hook contacts an upward surface of the hook groove.

4. The rotor assembly of claim 1, further comprising at least one second coupling portion configured to fix the rotor to the gear with respect to a rotation direction,
wherein the at least one second coupling portion includes:
a supporting rib protruding inward from an inner circumferential surface of the gear, and
a pair of press-fit ribs provided at the rotor, wherein the supporting rib is disposed between the pair of press-fit ribs.

5. The rotor assembly of claim 4, wherein at least one of the pair of press-fit ribs includes:
a second base portion extending upward from the rotor, and
one or more coupling protrusions protruding from a side surface of the second base portion in a circumferential direction and contacting a side surface of the supporting rib.

6. The rotor assembly of claim 5, wherein an upper surface of each of the one or more coupling protrusions is inclined.

7. The rotor assembly of claim 1, wherein:
the gear further includes a rotation support protruding outward from an outer circumferential surface of the gear, wherein at least a part of the rotation support is contactable with a housing.

8. The rotor assembly of claim 1, further comprising at least one second coupling portion configured to fix the rotor to the gear with respect to a rotation direction,
wherein:
the at least one first coupling portion comprises a plurality of first coupling portions and the at least one second coupling portion comprises a plurality of second coupling portions, and
the plurality of first coupling portions and the plurality of second coupling portions are alternately arranged along a circumferential direction between the rotor and the gear.

9. The rotor assembly of claim 1, further comprising a sleeve having substantially a hollow shape and disposed in the gear to rotate together with the steering shaft,
wherein the sleeve has a metal material and the gear has a plastic material.

10. The rotor assembly of claim 9, wherein the at least one first coupling portion further includes a hook guide surface provided at a lower end portion of an inner circumferential surface of the gear, wherein an inner diameter of the hook guide surface increases gradually downward.

11. A rotor assembly comprising:
a rotor having a through hole formed along an axial direction so that a steering shaft is inserted in the through hole of the rotor;
a gear having substantially a ring shape and coupled to the rotor; and
a fixing portion configured to fix the rotor to the gear, the fixing portion comprising:
at least one first coupling portion configured to fix the rotor to the gear with respect to the axial direction, the at least one first coupling portion comprising a hook protruding outward from an outer circumferential of the gear, and an elastically deformable or flexible hook rib having a hook groove penetrating the rotor or depressed from a surface of the rotor in a radial direction, wherein the hook is inserted in the hook groove of the hook rib.

12. The rotor assembly of claim 11, wherein the hook rib includes:
a first base portion extending upward from the rotor and facing an outer circumferential surface of the gear, and
the hook groove penetrating the first base portion or depressed from a surface of the first base portion in the radial direction.

13. The rotor assembly of claim 12, wherein an upper end portion of the hook contacts a downward surface of the hook groove.

14. The rotor assembly of claim 11, further comprising at least one second coupling portion configured to fix the rotor to the gear with respect to a rotation direction,
wherein the at least one second coupling portion includes
a supporting rib protruding inward from an inner circumferential surface of the gear; and
a pair of press-fit ribs provided at the rotor, wherein the supporting rib is disposed between the pair of press-fit ribs.

15. The rotor assembly of claim 14, wherein at least one of the pair of press-fit ribs includes
a second base portion extending upward from the rotor, and
one or more coupling protrusions protruding from a side surface of the second base portion in a circumferential direction and contacting a side surface of the supporting rib.

16. The rotor assembly of claim 15, wherein an upper surface of each of the one or more coupling protrusions is inclined.

17. The rotor assembly of claim 11, wherein the gear further comprises a rotation support protruding outward from an outer circumferential surface of the gear, wherein at least a part of the rotation support is contactable with a housing.

18. The rotor assembly of claim 11, further comprising at least one second coupling portion configured to fix the rotor to the gear with respect to a rotation direction
wherein:
the at least one first coupling portion comprises a plurality of first coupling portions and the at least one second coupling portion comprises a plurality of second coupling portions,
the plurality of first coupling portions and the plurality of second coupling portions are alternately arranged along a circumferential direction between the rotor and the gear.

19. The rotor assembly of claim 11, further comprising a sleeve having substantially a hollow shape and disposed in the gear to rotate together with the steering shaft,
wherein the sleeve has a metal material and the gear has a plastic material.

20. The rotor assembly of claim 11, wherein a surface of a lower portion of the hook is inclined.
